(19) United States
(12) Patent Application Publication
(10) Pub. No.: US 2022/0051129 A1
(43) Pub. Date: Feb. 17, 2022

(54) BLOCKCHAIN-ENABLED MODEL DRIFT MANAGEMENT

(71) Applicant: International Business Machines Corporation, Armonk, NY (US)

(72) Inventors: Abhishek Malvankar, White Plains, NY (US); Shikhar Kwatra, Raleigh, NC (US); Jeronimo Irazabal, Roque Perez (AR); Carlos A. Fonseca, LaGrangeville, NY (US)

(21) Appl. No.: 16/993,987

(22) Filed: Aug. 14, 2020

(51) Int. Cl. G06N 20/00; G06F 9/48; G06F 16/23

(52) U.S. Cl. CPC G06N 20/00; G06F 16/2379; G06F 9/4881

(57) ABSTRACT

A scheduler node in a blockchain network may receive data associated with a machine learning model. The scheduler node may measure a drift of the machine learning model for a first aspect of the data. The scheduler node may determine if the drift of the machine learning model is greater than a threshold. The scheduler node may schedule, in response to the drift being greater than the drift threshold, a retraining transaction for the machine learning model.

### BACKGROUND

The present disclosure relates generally to the field of blockchain visibility, and more specifically to drift management of machine learning models.

Blockchains offer immutability of data by replicating data across all nodes of a network and by cryptographically linking a history of changes. In order to be able to validate the blockchain, nodes generally require access to the complete history of actions, which any data on the chain is visible for all participants.

Technologies such as Internet of Things (IoT), Machine Learning (ML), robotics, advanced predictive analytics, and AI generate massive data. With changing technologies, data efficiency proves to be essential for creating new business innovations, infrastructure, and economics. These factors have significantly contributed to the growth of the market. With the widening scope of growth in data generation, companies are developing AI-enabled applications through machine learning and deep learning capabilities.

### SUMMARY

Embodiments of the present disclosure include a method, system, and computer program product for blockchain-enabled drift model management.

Some embodiments of the present disclosure can be illustrated by a method comprising, receiving, with a scheduler node in a blockchain network, data associated with a machine learning model, measuring, with the scheduler node, a drift of the machine learning model for a first aspect of the data, determining, with the scheduler node, that the drift of the machine learning model is greater than a drift threshold, and retraining, with the scheduler node and in response to the drift being greater than the drift threshold, the machine learning model.

Some embodiments of the present disclosure can also be illustrated by a system comprising a processor, in a node of a blockchain network, and a memory in communication with the processor, the memory containing program instructions that, when executed by the processor, are configured to cause the processor to perform a method comprising receiving data associated with a machine learning model, measuring a drift of the machine learning model for a first aspect of the data, determining that the drift of the machine learning model is greater than a drift threshold, and retraining, in response to the drift being greater than the drift threshold, the machine learning model.

Some embodiments of the present disclosure can also be illustrated by a computer program product comprising a computer readable storage medium having program instructions embodied therewith, the program instructions executable with a processor, in a node of a blockchain network, to cause the computer to receive data associated with a machine learning model, measure, with the scheduler node, a drift of the machine learning model for a first aspect of the data, determine that the drift of the machine learning model is greater than a drift threshold, and retrain in response to the drift being greater than the drift threshold, the machine learning model.

Some embodiments of the present disclosure can be illustrated by a method comprising, receiving, with a scheduler node in a blockchain network, a scheduled transaction proposal containing a transaction and a schedule for executing the transaction, waiting, with the scheduler node, for a scheduled transaction, and executing, with the scheduler node, the scheduled transaction.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a flow diagram of blockchain enabled drift management, according to example embodiments.

FIG. 2 illustrates a flow diagram of blockchain enabled drift management, according to example embodiments.

FIG. 3A illustrates a flow diagram of blockchain enabled drift management, according to example embodiments.

FIG. 3B illustrates a more detailed flow diagram of some elements of the blockchain enabled drift management depicted in FIG. 2A, according to example embodiments.

FIG. 4 illustrates a network diagram of a system including a database, according to an example embodiment.

FIG. 5A illustrates an example blockchain architecture configuration, according to example embodiments.

FIG. 5B illustrates a blockchain transactional flow, according to example embodiments.

FIG. 6A illustrates a permissioned network, according to example embodiments.

FIG. 6B illustrates another permissioned network, according to example embodiments.

FIG. 6C illustrates a permissionless network, according to example embodiments.

FIG. 7A illustrates a process for a new block being added to a distributed ledger, according to example embodiments.

FIG. 7B illustrates contents of a new data block, according to example embodiments.

FIG. 7C illustrates a blockchain for digital content, according to example embodiments.

FIG. 7D illustrates a block which may represent the structure of blocks in the blockchain, according to example embodiments.

FIG. 8A illustrates a cloud computing environment, in accordance with embodiments of the present disclosure.

FIG. 8B illustrates abstraction model layers, in accordance with embodiments of the present disclosure.

FIG. 9 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of machine learning models, and more specifically to blockchain-enabled model drift management.

It will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Detailed herein is a method, system, and computer program product that utilize blockchain (specifically, Hyperledger Fabric) channels, and smart contracts that implement logic based on a non-interactive zero knowledge proof.

In some embodiments, the method, system, and/or computer program product utilize a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency.

In various embodiments, a permissioned and/or a permission-less blockchain can be used. In a public or permission-less blockchain, anyone can participate without a specific identity (e.g., retaining anonymity). Public blockchains can involve native cryptocurrency and use consensus based on various protocols such as Proof of Work. On the other hand, a permissioned blockchain database provides secure interactions among a group of entities which share a common goal but which do not fully trust one another, such as businesses that exchange funds, goods, information, and the like.

Further, in some embodiments, the method, system, and/or computer program product can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The method, system, and/or computer program product can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded.

An endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

In some embodiments, the method, system, and/or computer program product can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node).

Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing/confirming transactions and modifying a world state of the blockchain, which is another name for the initial blockchain transaction which normally includes control and setup information.

In some embodiments, the method, system, and/or computer program product can utilize a ledger that is a sequenced, tamper-resistant record of all state transitions of a blockchain. State transitions may result from chaincode invocations (e.g., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain.

In some embodiments, the method, system, and/or computer program product described herein can utilize a chain that is a transaction log that is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (e.g., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Some benefits of the instant solutions described and depicted herein include a method, system, and computer program product for blockchain-enabled model drift management. The exemplary embodiments solve the issues of reliability, time, and trust by extending features of a database such as immutability, digital signatures, and being a single source of truth. The exemplary embodiments provide a solution for scheduling model retraining s on blockchain. The blockchain networks may be homogenous based on the asset type and rules that govern the assets based on the smart contracts.

Blockchain is different from a traditional database in that blockchain is not a central storage, but rather a decentralized, immutable, and secure storage, where nodes may share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the system described herein is implemented due to immutable accountability, security, privacy, permitted decentralization, availability of smart contracts, endorsements and accessibility that are inherent and unique to blockchain.

In particular, the blockchain ledger data is immutable and that provides for an efficient method for scheduling model retraining. Also, use of the encryption in the blockchain provides security and builds trust. The smart contract manages the state of the asset to complete the lifecycle, thus specialized scheduler nodes may ensure that models are retained when they need to be. The example blockchains are permission decentralized. Thus, each end user may have its own ledger copy to access. Multiple organizations (and peers) may be on-boarded on the blockchain network. The key organizations may serve as endorsing peers to validate the smart contract execution results, read-set and write-set. In other words, the blockchain inherent features provide for efficient implementation of processing a private transaction in a blockchain network.

One of the benefits of the example embodiments is that it improves the functionality of a computing system by implementing a method for processing a private transaction in a blockchain network. Through the blockchain system described herein, a computing system (or a processor in the computing system) can perform functionality for private transaction processing utilizing blockchain networks by providing access to capabilities such as distributed ledger, peers, encryption technologies, MSP, event handling, etc. Also, the blockchain enables systems to create a business network and make any users or organizations on-board for participation. As such, the blockchain is not just a database. The blockchain comes with capabilities to create a network of users and on-board/off-board organizations to collaborate and execute service processes in the form of smart contracts.

The example embodiments provide numerous benefits over a traditional database. For example, through the blockchain the embodiments provide for immutable accountability, security, privacy, permitted decentralization, availability of smart contracts, endorsements and accessibility that are inherent and unique to the blockchain.

Meanwhile, a traditional database may not be useful to implement the example embodiments because it does not bring all parties on the network, it does not create trusted collaboration and does not provide for an efficient storage of digital assets. The traditional database does not provide for a tamper proof storage and does not provide for preservation of the digital assets being stored. Thus, the proposed embodiments described herein utilizing blockchain networks cannot be implemented in the traditional database.

Meanwhile, if a traditional database were to be used to implement the example embodiments, data governance issues would arise. In particular, in a traditional database system a central authority would be required to manage and maintain data due to lack of trust between different parties. Using a central authority to share data may cause delays and increase security risks.

As the machine learning community continues to accumulate years of experience with live systems, a wide-spread and uncomfortable trend has emerged: developing and deploying ML systems is relatively fast and cheap but maintaining them over time is difficult and expensive. Even monitoring machine learning system behavior may prove difficult without careful design.

Predictive modeling is teaching a model from historical data and using the model to make predictions on new data where the answer is unknown. Data can change over time. This can result in poor and degrading predictive performance in predictive models that assume a static relationship between input and output variables. This problem of the changing underlying relationships in the data is called concept drift or drift in the field of machine learning.

Technically, predictive modeling is the problem of approximating a mapping function (f) given input data (X) to predict an output value (y), e.g., y=f(X).

In some cases, this mapping is assumed to be static, meaning that the mapping learned from historical data is just as valid in the future on new data and that the relationships between input and output data do not change. However, in some cases, the relationships between input and output data can change over time, meaning that in turn there are changes to the unknown underlying mapping function. The changes may be consequential, such as that the predictions made by a model trained on older historical data are no longer correct or as correct as they could be if the model was trained on more recent historical data.

Concept drift or drift in machine learning and data mining refers to the change in the relationships between new input (actual results the model may be compared to, called results data herein) and the predicted output data in the underlying problem over time. Drift may also be called “covariate shift,” “dataset shift,” or “nonstationarity.”

These changes, in turn, may be able to be detected, and if detected, it may be possible to update the learned model to reflect these changes. The change to the data could take many forms. In some instances, there is some temporal consistency to the change such that data collected within a specific time period show the same relationship and that this relationship changes smoothly over time.

Some types of changes may include a gradual change over time (e.g., growing data sets), a recurring or cyclical change (e.g., yearly policy changes or data reporting), and/or a sudden or abrupt change (e.g., emergency guidance or a reported inconsistency). In some embodiments, a blockchain-enabled drift management solution is proposed for managing data change in machine learning models.

In some instances, data may come from a wide variety of third-party sources such as subject matter experts, annotators, data mining organizations, etc. In some embodiments, data may be received directly from a third-party source. In some embodiments, a node may record a transaction in the block chain ledger with data information. In some embodiments, the actual data may be stored in a distributed file storage and references in the transaction.

In some embodiments, the drift measurement may be provided by a third party drift measuring service (DMS). A DMS may compare model predictions to data as the data is generated and then provide the drift to a processor (e.g., a scheduler node). In some embodiments, the DMS may be associated with a peer (DMS node) which may perform one or more of the DMS services. In some embodiments, the DMS node may record a transaction in the blockchain ledger with drift information. In some embodiments, the drift information may include the drift and/or a location in a distributed file storage where drift data (e.g., one or more drifts) may be located.

In some embodiments, communication or data exchange with a model consumer, described herein, may be performed through a node associated with a model consumer. In some embodiments, the model consumer may receive and implement the model. In some embodiments, the model consumer may retrieve the model from a distributed file storage. In some embodiments, the model consumer may report model predictions on the blockchain ledger as a transaction. In some embodiments, the transaction may have data on a file stored on a distributed file storage. In some embodiments, the model consumer may report collected data from their operations linked to the model on the blockchain ledger as a transaction.

In some embodiments, guidelines may be received from a third-party organization. In some embodiments, the guidelines may be used as data to train a model. For example, governing bodies or organizations (e.g., center for disease control (CDC) or the New York stock exchange) may provide new guidelines (e.g., minimum quarantine period) or other data (e.g., stock dividends).

In some embodiments, model developer may refer to a peer (e.g., node or developer node). In some embodiments, a model developer may be associated with a third party that creates and/or maintains a model. In some embodiments, a model developer may receive a request to create or retrain a model. In some embodiments, the request may be recorded on the ledger as a transaction.

In some embodiments, one or more nodes in the blockchain network may be designated as a scheduler node. In some embodiments, the scheduler node may receive data pertaining to the model, receive retraining requests, determine if a model should be retrained, and schedule retraining of models. In some embodiments, retraining refers to re-running the process that generated the previously selected model on a new training set of data (or new data in addition to the previously used data). The features, model algorithm, and hyperparameter search space may all remain the same. In some instances, the retraining does not involve any code changes.

Historically model consumers have requested model retraining, however that creates several issues. Notably, if a consumer submits a retraining request as a transaction it may not be entered into the blockchain ledger and thus the model retraining may be delayed or not performed. For example, the transaction may be invalidated.

Next, model consumers may only send requests at regular intervals or when new data becomes available. This may lead to updates happening too frequently or not frequently enough. In some instances, new data may show that a model is inaccurate and needs retrained when an update is not scheduled. For example, the model may need to be retrained if actual client purchases have shifted away from model predictions, perhaps in response to a new event such as a global event. The shift in purchases may lead to shortages in ordered items, such as masks. In other instances, a model may be retrained when there is not a need because the new data would not significantly change the model. For example, if new guidance may come in from the CDC, but the model already comports with the guidance, the model would not need to be retrained.

Finally, current systems place onerous duties on the model consumers. Model consumers need to constantly keep apprised of new data, determine schedules, make requests to drift measuring services and model developers, make sure all transactions are recorded on the blockchain network, and make sure each request is comported with.

In some embodiments, a two-pronged solution is proposed. First, in some embodiments, multiple scheduler nodes may be designated to determine when a model needs to be retrained and to schedule retraining of a model. The multiple scheduler nodes may be jointly responsible for transactions associated with scheduling of retrainings. Second, in some embodiments, a blockchain network may be used to monitor data associated with a model, including drift data, and schedule a model to be retrained.

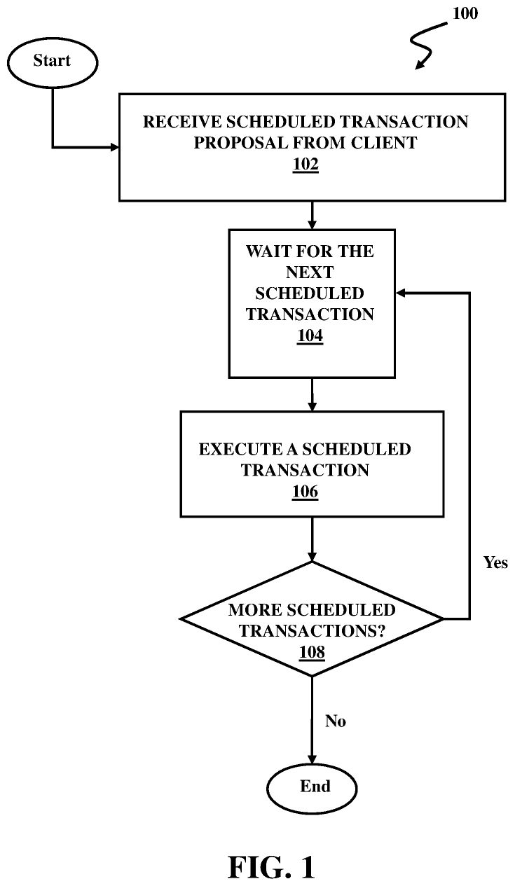

Referring now to FIG. 1, illustrated is a flowchart of an example method 100 for scheduling a transaction, in accordance with embodiments of the present disclosure. In some embodiments, the method 100 is performed by a scheduler processor (e.g., scheduler node, etc.) on a blockchain network.

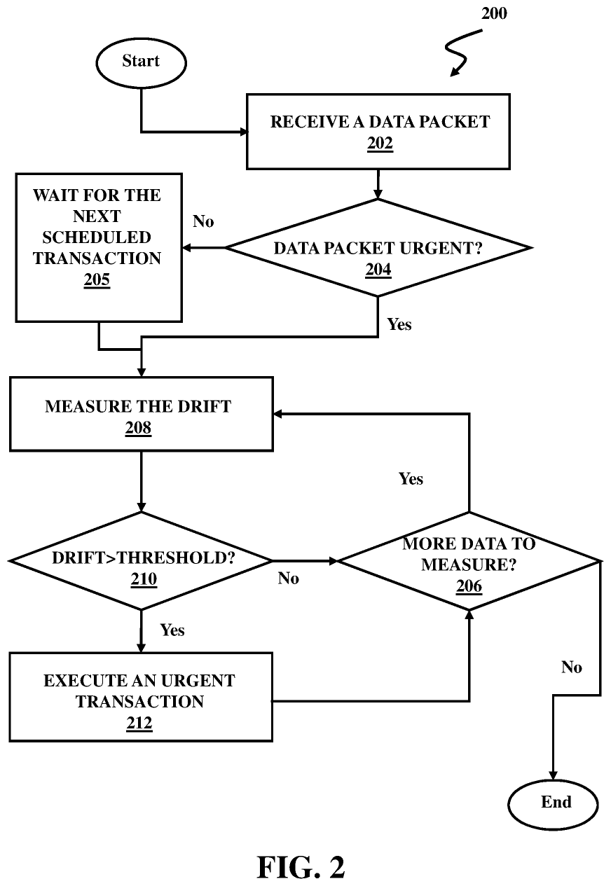

Method 100 begins with operation 102 where a scheduler processor may receive a transaction proposal from a client. In some embodiments, the transaction proposal may include a transaction and schedule (e.g., a frequency for transaction execution). For example, the transaction may be to retrain a machine learning model, a query of how many units have been shipped, a payment instructions as part of a smart contract, etc. and the frequency for execution may be every 24 hours, once a week, specific dates, etc. Transaction proposals are described in further detail in operation 202 of FIG. 2 below.

In operation 104, the scheduler node may wait for the next scheduled transaction based on the transaction proposal schedule. For example, if the transaction proposal schedule indicated that the transaction should be run every 24 hours and the transaction ran 23 hours ago, the scheduler node may wait 1 more hour before proceeding to operation 106.

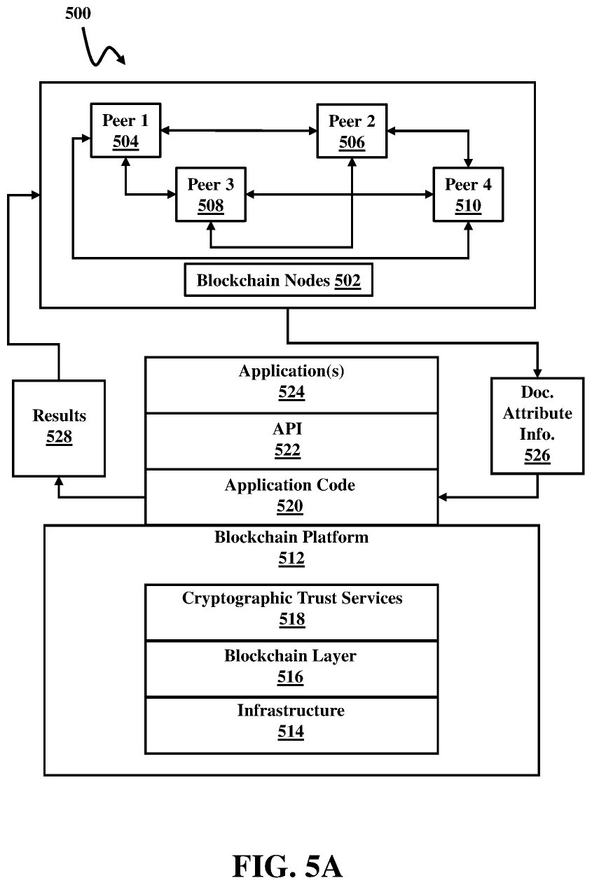

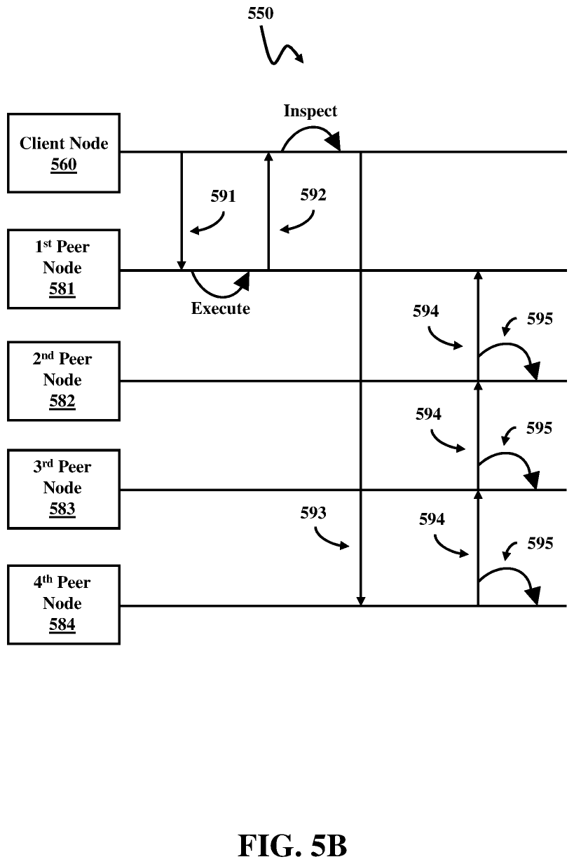

In operation 106, the scheduler node may execute the scheduled transaction. Information on executing transactions may be found in at least FIGS. 5A and 5B.

In operation 108, the scheduler node may determine if there are more scheduled transactions according to the transaction proposal. In some embodiments, the transactions may be scheduled indefinitely. For example, the transactions may be scheduled every 24 hours with no end date. In some embodiments, the transaction schedule may indicate a total number of transactions to be executed, or a final date for the transaction execution. If another transaction is scheduled, the method may return to operation 104. If no further transactions are scheduled, the method may end.

Referring now to FIG. 2, illustrated is a flowchart of an example method 200 for blockchain-enabled model drift management, in accordance with embodiments of the present disclosure. In some embodiments, the method 200 is performed by a scheduler processor (e.g., scheduler node, etc.) on a blockchain network.

In some embodiments, the method 200 begins at operation 202, where the scheduler processor receives a training data (e.g., a transaction) related to scheduling a retraining of a machine learning model. In some embodiments, the training data includes information (e.g., data or location of data in a distributed file storage) related to a scheduled transaction proposal from a model consumer, model prediction data, result data from the model consumer, and/or data from a third party (e.g., a document from a guideline resource organization such as the center for disease control or a data provider such as an annotation service). In some embodiments, a scheduled transaction proposal may be a request to retrain a model, a proposed schedule for model retraining, and/or one or more guidelines for retraining models (e.g., a drift threshold). For example, a model consumer may request that a model retraining be scheduled and provide results data for measuring model drift and model retraining. In some embodiments, the drift may be compared to a drift threshold to determine if a model needs to be retrained. In some embodiments, a drift threshold is determined by the model consumer. For example, a model consumer may require that a model is retrained whenever the drift reaches a certain number or rises above a line on a graph, other types of drift thresholds are possible. The drift threshold is described further in operation 210 below.

In some embodiments, the data and/or the data location in a distributed file storage may be recorded on a blockchain ledger.

Method 200 continues at operation 204 where the scheduler processor determines if the training data is urgent. In some embodiments, an urgent training data may be data from a governing organization with new guidance or a significant change in data. For example, the training data may be urgent if the center for disease control changes an incubation period from one week to two weeks, or if customer demand goes from 200 masks a month to 100,000 masks a month. An urgent transaction may be denoted in metadata associated with the training data or it may be based on one or more guidelines or urgency thresholds provided by the model consumer. For example, a guideline may say that any data from a particular (e.g., center for disease control) organization is urgent or that any results data that changes by more than 15 percent is urgent. If it is determined at operation 204 that the training data is urgent, the method may continue directly to operation 208.

If it is determined at operation 204 that the training data is not urgent, the method may continue to operation 205. At operation 205, the scheduler processor may wait for the next scheduled transaction. In the example provided by FIG. 2, the next transaction may be a drift measurement, but in some examples, it may also be another transaction such as a retraining of a machine learning model. In some embodiments, the scheduler processor sends data and predictions to a drift measurement service at preplanned intervals based on when it may receive data. For example, if the scheduler node receives results data from the model consumer on a weekly basis, the scheduler may execute a scheduled transaction (such as a drift measurement or a retraining) on a weekly basis. In some embodiments, the interval may be called a prediction cycle. For instance, a prediction cycle could be when results data is available to compare to model results. In a more detailed example, if mask sales data is available every quarter, the scheduler processor may execute a scheduled transaction (such as a drift measurement or retraining a machine learning model) every quarter after the data is available. Scheduled transactions are discussed in more detail in FIG. 1 above.

In some embodiments, an urgency may be determined with an “urgency value.” Determining if data (e.g., training data) is urgent may be based on comparing the “urgency value” to a threshold, where any number equal to or above a threshold may be considered urgent and any “urgency value” below the threshold would be considered not urgent. The “urgency value” may be impacted by a change in reported values (e.g., a drastic change in the results data), the data source (e.g., increase the value for more important or reliable sources), or other factors that indicate that a model should be retrained. For example, the “urgency value” may be a number from 0 to 200, where 0-50 is not urgent enough for a retraining to be triggered and any number above 50 (e.g., the urgency threshold) is urgent and the model needs to be retrained immediately. Using this example, data from the center for disease control may be a +50 to the urgency value simply because it is from the CDC. Other scoring metrics are possible.

Once the current prediction cycle is complete, the scheduler processor may move to operation 208.

If it is determined at operation 204 that the training data is urgent or if a drift measurement is scheduled, the method may continue to operation 208. At operation 208, the scheduler processor may measure current model drift. “Drift” in machine learning and data mining refers to the change in the relationships between new results data (actual results the model is predicting, called results data herein) and the predicted output data in the underlying problem over time. The results data may be used, in conjunction with other input data, to retrain the model. For example, a model predicting how long it may take for a customer to receive a mask after ordering may predict 10 days. If the actual delivery time is 20 days, the drift may be the difference between the prediction and reality (e.g., the average of the results data). In this example, the drift may be 10 days or 100%. Other methods of calculating drift are possible.

Method 200 continues at operation 210, where the scheduler processor may determine if the drift exceeds a drift threshold. In some embodiments, the drift threshold may be an acceptable drift level, where drifts below the drift threshold are acceptable (e.g., do not need to be retrained) and drifts above the drift threshold indicate that the machine may need to be retrained. Following the mask delivery example from above, for a threshold of two days and a model prediction of 10 days, any delivery averages below 8 days or above 12 days may indicate the model needs to be retrained. Delivery averages from 8-12 days may indicate that the model does not need retrained. If the drift is above a threshold, the method may move to operation 262. In some embodiments, the drift threshold may be set by the model consumer.

If the drift is not above the threshold, the method may return to operation 208 to measure drift on another aspect of the data. In some embodiments, aspect refers to a part, category, or section of the data that drift may be measured on. For example, in a model determining delivery time for a mask, a model may be trained on and predict several aspects of the data such as supply, demand, processing time, and shipping time. In some embodiments, drift may be measured for each aspect of the data. For example, drift may be calculated on supply, demand, processing time, and/or shipping time.

If the drift has not crossed a drift threshold, the scheduler processor moves to operation 206 where it is determined if there is more data (e.g., more drifts) to be measured. If there are more drifts to measure, the method may return to operation 208 and may measure current model drift. In some embodiments, operation 206 may involve sending a request to a system drift measuring service to request that the drift measuring service determine if there are more drift measurements. In some embodiments, the request may include new prediction data. If there are not more drifts to be measured, the method may end.

At operation 212 the scheduler processor may execute an urgent transaction (for example an urgent retraining transaction) based on a determination that the data packet is urgent. In some embodiments, an urgent transaction, such as an urgent retraining transaction, will invoke a notification. For example, a notification that the model should be retrained may be sent to a client or a client node when the drift is above a threshold. In some embodiments, a notification that the model should be retrained may be sent to a service node associated with the model training service developer. In some embodiments, the notification may include the drift measurement. In some embodiments, the notification may include new results data. In some embodiments, a notification may be sent out to a model training service provider. In some embodiments, sending the notification includes committing a smart contract for the retraining on the blockchain network. In some embodiments, the fulfillment of the smart contract is reliant on the model training service developer retraining the model and sending the model to the model consumer for redeployment. After the model is retrained and/or deployed, the method may move to operation 206 and determine if there is more data to measure. In some embodiments, labeling a transaction as an urgent transaction may give it priority of over some other transactions. In some embodiments, labeling a transaction as urgent may cause the urgent transaction to be executed immediately instead of waiting for the next scheduled transaction. For example, if a scheduled transaction is to be executed in 24 hours, but urgent data is received, an urgent transaction based on the urgent data may be executed immediately. In some embodiments, immediately means in put in a queue for execution.

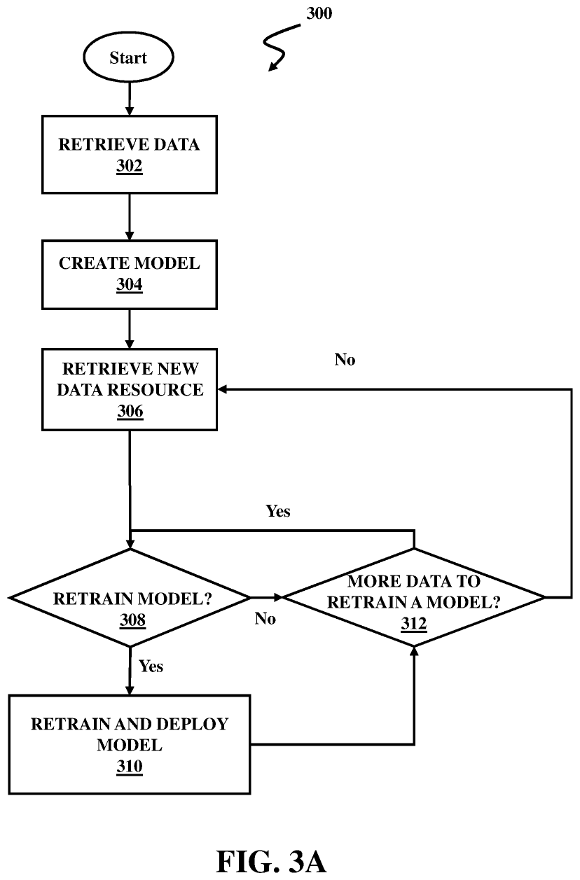

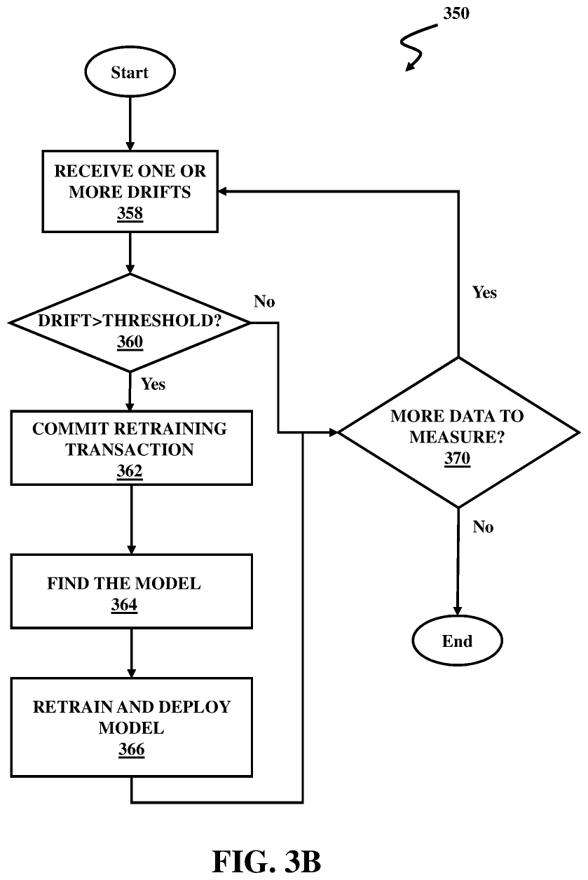

Referring now to FIG. 3A, illustrated is an example method 300 for creating and determining when a model should be retrained, in accordance with embodiments of the present disclosure.

Method 300 begins with operation 302, where a scheduler processor may receive data from one or more sources. In some embodiments, the data may include model prediction data, results data from the model consumer, and/or data from a third party (e.g., a document from a resource organization such as the center for disease control or a data provider such as an annotation service), or some combination therein.

Method 300 may continue with operation 304, where a scheduler processor may create a model and add metadata about the model. In some embodiments, the metadata may be data relating to the function of the model (e.g., what data it receives as an input and predicts as an output). In some embodiments, the model may be a modification of a model that has already been created. In some embodiments, the scheduler processor may be tasked with initially creating a model. In some embodiments, the new model may be an augmentation of an existing model. For example, if a machine learning collective (formed of multiple sub-models, see next paragraph) is missing an important data prediction point, a new model may need to be generated. For example, a missing data point could be when a model predicts delivery time, but there is not yet a sub-model predicting demand. In some embodiments, the scheduler processor may determine that a new model needs to be created when a it receives a request from a model consumer to create a new model, when a model or model collective produces an error, or when model drift exceeds a certain drift threshold identified by a model consumer. In some embodiments, the model consumer may provide a first drift threshold for model retraining and a second threshold indicating a supplemental model may be needed. For example, the scheduler processor may receive, from the model consumer, a drift threshold of +/−2 hours for processing time, or a drift of +/−50 units for supply. If the model does not contain a model predicting processing time, the scheduling processor may determine that the model additionally needs a sub-model predicting processing time.

Machine learning models often do not operate independently but form a collective process or a multi-agent system (formed of machine learning models called sub-models herein. For example, if a model consumer wants to determine how long after ordering a customer may receive a mask, it may take multiple models to predict how long it may take for the customer to receive the mask. A first model (model A) may predict supply, a second model (model B) may predict demand, a third model (model C) may predict processing time, and a fourth model (model D) may predict shipping time. All four of these models may input into a final model (model E) or final classifier that may take an output from the first four models as an input and predict how long it may take for a customer to receive a mask. It will be understood that some model systems may have multiple levels of models and different levels may require different types of resources (e.g., data/inputs). Following the previous example, the output of model A and B may be the input of model C, and the output of model C and D may be the input of model E. In another example, model A may need a number of units ordered from a supplier, model B may need a graph of demand vs. season, and model D may need information relating to what types of shipping are available and what the estimated time for shipping may be. In some instances, the final model may be a rule-based states model.

Method 300 proceeds with operation 306, where the scheduler processor may add a new data resource to the system. In some embodiments, the new data resource may be data that the system records on the blockchain ledger either by adding the actual data to the ledger or information on where the data is stored on a distributed ledger. The new data resource may be a data resource received from the model consumer or a third party (such as a model training service developer, a guideline data resource generator, or a system drift measuring service). In some embodiments, a notification to a system drift measuring service requesting a drift measurement may be sent when a new data resource is added. In some embodiments, the drift measuring service may determine a drift when a new data resource is added to the system.

Method 300 includes decision block 308 where the scheduler processor may determine if the model needs to be retrained. Decision Block 308 may include analyzing the drift to determine if it has exceeded a drift threshold, as discussed in more detail in FIG. 3B below. In some embodiments, retraining refers to re-running the process that generated the previously selected model on a new training set of data (or new data in addition to the previously used data). The features, model algorithm, and hyperparameter search space may all remain the same. In some instances, the retraining does not involve any code changes.

In operation 310, the scheduler processor may retrain the models using the new data and deploy the retrained model. In some embodiments, retraining the model includes recording a transaction on the blockchain that indicates the model should be retrained and a model training service developer retraining the model based on the transaction. In some embodiments, the scheduler processor may send a notification to a model training service developer to retrain the model. In some embodiments, the model training service developer may record an indication that the model has been retrained on the blockchain. In some embodiments, the scheduler processor may send a notification to the model consumer indicating that the model has been retrained and should be deployed. In some embodiments, method 300 may proceed to operation 312. At operation 312 the scheduler processor determines if there is more data to retrain the model on. If there is more data to train a model on, Method 300 may proceed to operation 308 to train the model on the same set of data. Different aspects of a model may be retrained on the same set of data, as described in FIG. 3B below. If there is not any more data to retrain a model on the method may return to operation 306 to retrieve a new data source.

In some embodiments, deployment of machine learning models (i.e., putting models into production) includes making the models available to a system that may use the model. By deploying models, other systems can send data to them and get their predictions, which are in turn populated back into the company systems. In some embodiments, deployment of the machine learning model includes recording a transaction on the blockchain ledger stating that the model has been retrained and/or the model consumer has deployed the model.

In some embodiments, a more detailed variation of blocks 306, 308, and 310 are discussed in FIG. 3B.

Regarding FIG. 3B, method 350 includes operation 358, where a scheduler processor receives one or more drifts. In some embodiments, the one or more drifts may be received from a model measuring service that calculates the one or more drifts. For example, the scheduler processor may receive, from a drift measuring service, a drift of 2 hours for processing time, or a drift of 37 units for supply. This is a simple example of possible drifts, but drifts may be calculated many ways and may be more complex. In some embodiments, a model may have multiple outputs. For example, as explained below, a model may be comprised of multiple sub-models, and a drift measurement could be performed for each sub-model. In some embodiments, method 350 could be performed for each sub-model. For example, one or more drifts may be received for a first sub-model and then, after method 350 has run a first time, one or more drifts may be received for a second sub model and method 350 may be run a second time. In an alternative example, one or more drifts pertaining to the first sub-model and the second sub-model could be received together. In some embodiments, the correlation of which drifts relate to which sub-models may be determined in operation 364. In some embodiments, a scheduler processor may send data to a system drift measuring service and receive one or more drifts. In some embodiments, method 350 may be an iterative process, where one or more drifts for a model may be calculated each time a sub model is retrained.

In operation 360, the scheduler processor determines if the drift has crossed a drift threshold. In some embodiments, a machine learning model may have multiple drift thresholds. For example, there may be a drift threshold for each aspect of the data or for each sub-model. Following the example from above, a threshold for model A (predicting supply) may be +/−100 units from the predicted units in the supply, and a threshold for model C (predicting processing time) might be +/−3 hours from the predicted processing time. In some embodiments, the drift threshold may be an acceptable drift level set by the model consumer, where drifts below the drift threshold are acceptable and drifts above the drift threshold should indicate that the machine may need to be retrained. Other methods of determining a drift threshold may be possible.

If the drift has not crossed a drift threshold, the scheduler processor moves to operation 370 where it is determined if there is more data (e.g., more drifts) to be measured. If there are more drifts to measure, the method may return to operation 358 and receive one or more additional drift measurements from the system drift measuring service. In some embodiments, operation 370 may involve sending a request to a system drift measuring service to request the drift measuring service determine if there are more drift measurements. In some embodiments, the request may include new prediction data. If there are not more drifts to be measured, the method may end. In some embodiments, the data may have many aspects drift may be measured on. For example, data for supply and processing time may be intertwined, but a drift could be measured for each aspect (e.g., supply or processing time). With respect to some embodiments, “aspect of the data” refers to a way the data can be structured such that a drift measurement may be determined. In some embodiments, the scheduler processor may determine if there is more data to be measured by determining that a second aspect of the data that can be measured for a second drift measurement. For example, if a first iteration of method 350 had a drift measurement for supply, 370 may determine if there is another aspect (e.g., processing time) where a drift may be measured.

If, on the other hand, scheduler processor determines that the drift has not crossed the drift threshold in operation 360, the scheduler processor may commit a retraining transaction to the distributed ledger in operation 362 and send out notifications, stating that a model does not need to be retrained, to a modeling service developer and/or a model consumer. In some embodiments, the retraining transaction may indicate that the drift was outside a drift threshold and the model may need to be retrained.

In operation 364, the scheduler processor may identify what model, models, sub-model, or sub-models are associated with the drift measurement and/or drift threshold so that the retraining (performed in operation 366) may be directed to the identified models or sub-models. In some embodiments, a scheduler processor may selectively determine which model, models, sub-model, or sub-models may benefit from retraining and which may not change significantly if they are retrained. As described above, a model may be comprised of multiple sub-models, or a system may have multiple models associated with a drift measurement. In some embodiments, the models may have metadata tags that indicate what data a model predicts and in operation 364 the metadata tags may be compared to the data that was used to calculate the drift. For example, model A may be tagged with “supply,” indicating that model A predicts supplies of goods. If supply data was used to calculate the drift, model A may be selected in operation 364 when this “supply” tag is found to match “supply data.” In some instances, multiple models may be associated with the drift. In some embodiments, the scheduler processor may need to determine which models are associated with the drift. Following the example from above where the output of model A and B may be the input of model C, if the drift associated with the output of model C is above a drift threshold, then the system may determine which model (A, B, or C) is most likely responsible for the drift. If data associated with the input of model A has changed significantly, but the data associated with the input of model B has not, then the scheduler processor may determine that models A and C need to be retrained. Other methods of determining which models should be retrained are possible.

In operation 366, the scheduler processor may retrain the models using the new data and deploy the retrained model. In some embodiments, retraining the model includes recording a transaction on the blockchain that indicates the model should be retrained. The retraining may be directed to the model or sub-model identified in 364. For example, the retraining may incorporate a high percentage of data that is relevant to the particular model or sub-model, or may alter only the weights and biases of the identified model or sub-model. In some embodiments, the scheduler processor may send a notification to a model training service developer to retrain the model. In some embodiments, the model training service developer may record a transaction on the blockchain indicating that the model has been trained. In some embodiments, the scheduler processor may send a notification to the model consumer indicating that the model has been retrained and should be deployed. Method 350 may proceed to operation 370 described above. Following the example from above, models A and B may need to be retrained before an accurate drift measurement of model C could be determined since C uses the output of A and B.

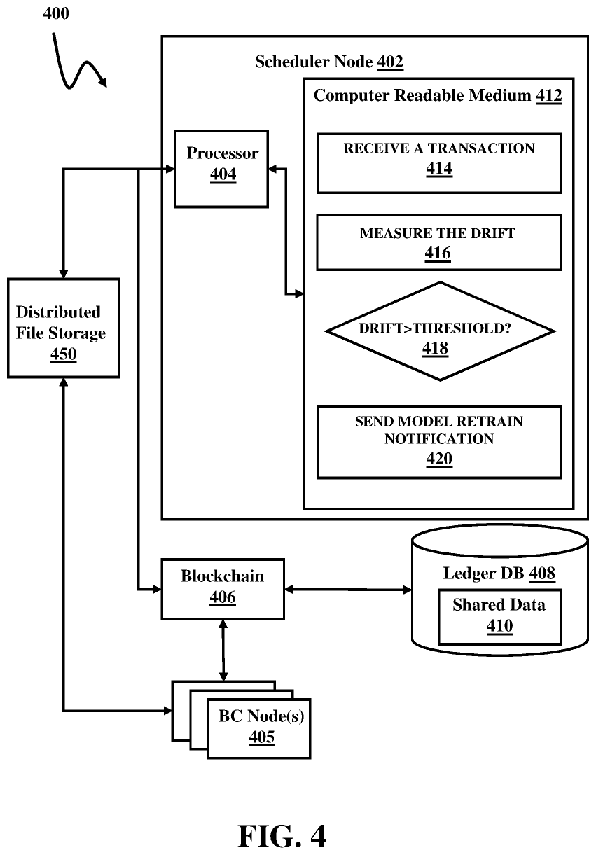

FIG. 4 illustrates a logic network diagram for smart data annotation in blockchain networks, according to example embodiments.

Referring to FIG. 4, the example network 400 includes a scheduler node 402 connected to other blockchain (BC) nodes 405 representing document-owner organizations. The scheduler node 402 may be connected to a blockchain 406 that has a ledger 408 for storing data to be shared among the nodes 405. While this example describes in detail only one scheduler node 402, multiple such nodes may be connected to the blockchain 406. It should be understood that the scheduler node 402 may include additional components and that some of the components described herein may be removed and/or modified without departing from a scope of the scheduler node 402 disclosed herein. The scheduler node 402 may be a computing device or a server computer, or the like, and may include a processor 404, which may be a semiconductor-based microprocessor, a central processing unit (CPU), an application specific integrated circuit (ASIC), a field-programmable gate array (FPGA), and/or another hardware device. Although a single processor 404 is depicted, it should be understood that the scheduler node 402 may include multiple processors, multiple cores, or the like, without departing from the scope of the scheduler node 402 system. A distributed file storage 450 may be accessible to processor node 402 and other BC nodes 405. The distributed file storage may be used to store documents identified in ledger (distributed file storage) 450.

The scheduler node 402 may also include a non-transitory computer readable medium 412 that may have stored thereon machine-readable instructions executable by the processor 404. Examples of the machine-readable instructions are shown as 414-420 and are further discussed below. Examples of the non-transitory computer readable medium 412 may include an electronic, magnetic, optical, or other physical storage device that contains or stores executable instructions. For example, the non-transitory computer readable medium 412 may be a Random Access memory (RAM), an Electrically Erasable Programmable Read-Only Memory (EEPROM), a hard disk, an optical disc, or other type of storage device.

The processor 404 may execute the machine-readable instructions 414 to receive a transaction. As discussed above, the blockchain ledger 408 may store data to be shared among the nodes 405. The blockchain 406 network may be configured to use one or more smart contracts that manage transactions for multiple participating nodes. Documents linked to the annotation information may be stored in distributed file storage 450. The processor 404 may execute the machine-readable instructions 416 to measure the drift. The processor 404 may execute the machine-readable instructions 418 to determine if the drift is above a drift threshold. The processor 404 may execute the machine-readable instructions 420 to send a model retraining notification to the appropriate nodes and/or organizations.

FIG. 5A illustrates a blockchain architecture configuration 500, according to example embodiments. Referring to FIG. 5A, the blockchain architecture 500 may include certain blockchain elements, for example, a group of blockchain nodes 502. The blockchain nodes 502 may include one or more peer nodes 504-510 (these four nodes are depicted by example only). These nodes participate in a number of activities, such as blockchain transaction addition and validation process (consensus). One or more of the blockchain nodes 504-510 may endorse transactions based on endorsement policy and may provide an ordering service for all blockchain nodes in the architecture 500. A blockchain node may initiate a blockchain authentication and seek to write to a blockchain immutable ledger stored in blockchain layer 516, a copy of which may also be stored on the underpinning physical infrastructure 514. The blockchain configuration may include one or more applications 524 which are linked to application programming interfaces (APIs) 522 to access and execute stored program/application code 520 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 504-510.

The blockchain base or platform 512 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 516 may expose an interface that provides access to the virtual execution environment necessary to process the program code and engage the physical infrastructure 514. Cryptographic trust services 518 may be used to verify transactions such as asset exchange transactions and keep information private.

The blockchain architecture configuration of FIG. 5A may process and execute program/application code 520 via one or more interfaces exposed, and services provided, by blockchain platform 512. The code 520 may control blockchain assets. For example, the code 520 can store and transfer data, and may be executed by nodes 504-510 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the document attribute(s) information 526 may be processed by one or more processing entities (e.g., virtual machines) included in the blockchain layer 516. The result 528 may include a plurality of linked shared documents. The physical infrastructure 514 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

FIG. 5B illustrates an example of a blockchain transactional flow 550 between nodes of the blockchain in accordance with an example embodiment. Referring to FIG. 5B a general description of transactional flow 550 will be given followed by a more specific example. The transaction flow may include a transaction proposal 591 sent by an application client node 560 to an endorsing peer node 581. The endorsing peer 581 may verify the client signature and execute a chaincode function to initiate the transaction. The output may include the chaincode results, a set of key/value versions that were read in the chaincode (read set), and the set of keys/values that were written in chaincode (write set). The proposal response 592 is sent back to the client 560 along with an endorsement signature, if approved. The client 560 assembles the endorsements into a transaction payload 593 and broadcasts it to an ordering service node 584. The ordering service node 584 then delivers ordered transactions as blocks to all peers 581-583 on a channel. Before committal to the blockchain, each peer 581-583 may validate the transaction. For example, the peers may check the endorsement policy to ensure that the correct allotment of the specified peers have signed the results and authenticated the signatures against the transaction payload 593. In some embodiments, one or more of the peers may be the manager nodes.

A more specific description of transactional flow 550 can be understood with a more specific example. To begin, the client node 560 initiates the transaction 591 by constructing and sending a request to the peer node 581, which is an endorser. The client 560 may include an application leveraging a supported software development kit (SDK), which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 581 may verify (a) that the transaction proposal is well formed, (b) the transaction has not been submitted already in the past (replay-attack protection), (c) the signature is valid, and (d) that the submitter (client 560, in the example) is properly authorized to perform the proposed operation on that channel. The endorsing peer node 581 may take the transaction proposal inputs as arguments to the invoked chaincode function. The chaincode is then executed against a current state database to produce transaction results including a response value, read set, and write set. However, no updates are made to the ledger at this point. In 592, the set of values, along with the endorsing peer node's 581 signature is passed back as a proposal response 592 to the SDK of the client 560 which parses the payload for the application to consume.

In response, the application of the client 560 inspects/verifies the endorsing peers signatures and compares the proposal responses to determine if the proposal response is the same. If the chaincode only queried the ledger, the application would inspect the query response and would typically not submit the transaction to the ordering service node 584. If the client application intends to submit the transaction to the ordering node service 584 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node may need to endorse the transaction. The architecture is such that even if an application selects not to inspect responses or otherwise forwards an unendorsed transaction, the endorsement policy may still be enforced by peers and upheld at the commit validation phase.

After successful inspection, the client 560 assembles endorsements into a transaction 593 and broadcasts the transaction proposal and response within a transaction message to the ordering node 584. The transaction may contain the read/write sets, the endorsing peers signatures and a channel ID. The ordering node 584 does not need to inspect the entire content of a transaction in order to perform its operation. Instead, the ordering node 584 may simply receive transactions from all channels in the network, order them chronologically by channel, and create blocks of transactions per channel.

The blocks of the transaction are delivered from the ordering node 584 to all peer nodes 581-583 on the channel. The transactions 594 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 595 each peer node 581-583 appends the block to the channel's chain, and for each valid transaction the write sets are committed to current state database. An event is emitted to notify the client application that the transaction (invocation) has been immutably appended to the chain, as well as to notify whether the transaction was validated or invalidated.

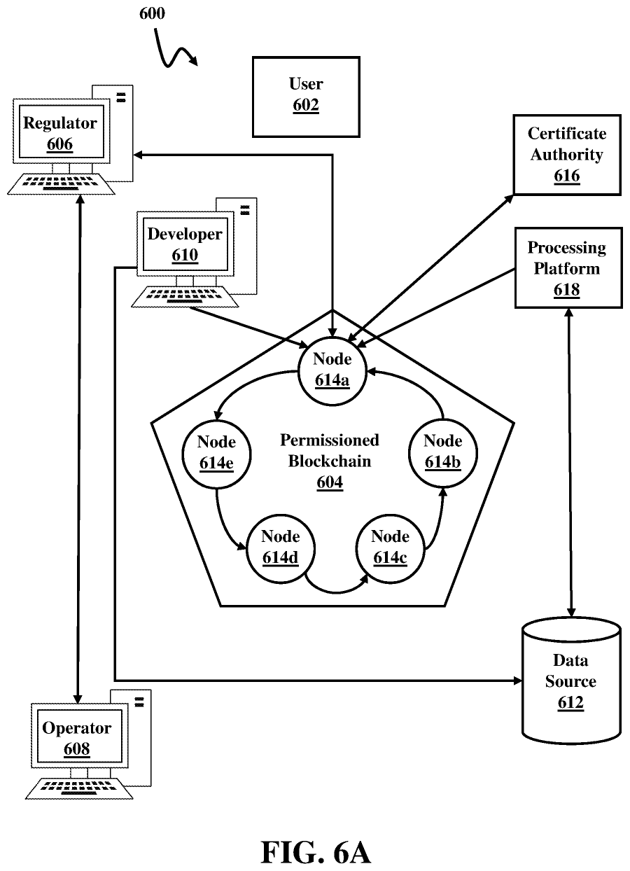

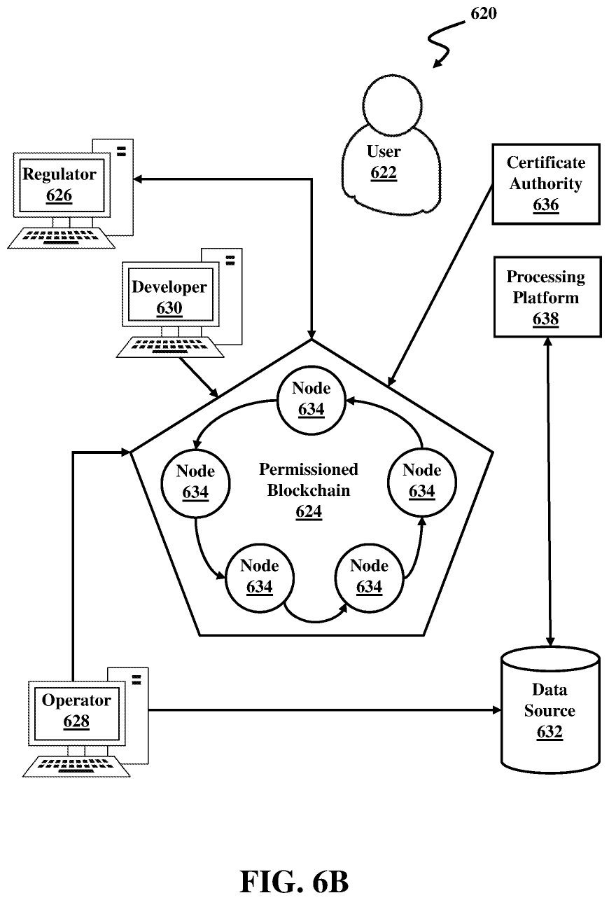

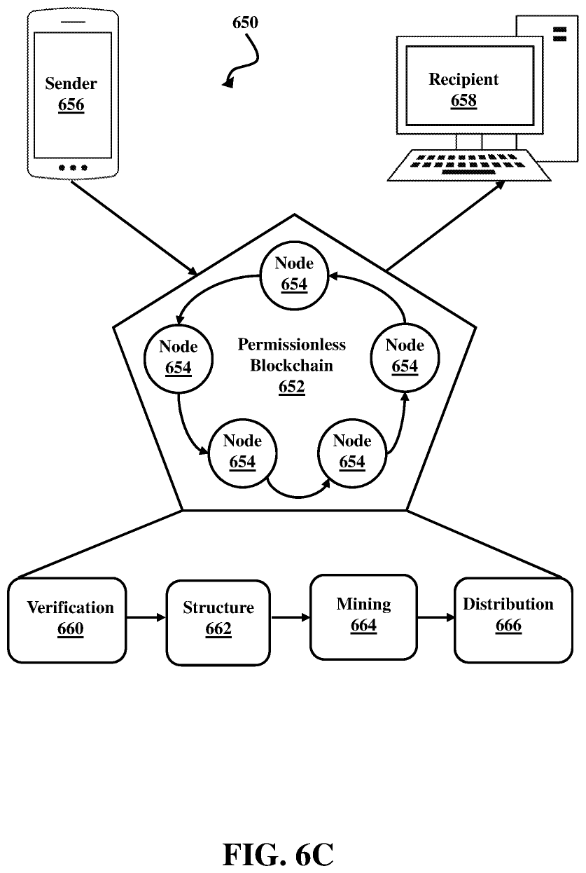

FIG. 6A illustrates an example of a permissioned blockchain network 600, which features a distributed, decentralized peer-to-peer architecture. In this example, a blockchain user 602 may initiate a transaction to the permissioned blockchain 604. In this example, the transaction can be a deploy, invoke, or query, and may be issued through a client-side application leveraging an SDK, directly through an API, etc. Networks may provide access to a regulator 606, such as an auditor. A blockchain network operator 608 manages member permissions, such as enrolling the regulator 606 as an “auditor” and the blockchain user 602 as a “client.” An auditor may be restricted only to querying the ledger whereas a client may be authorized to deploy, invoke, and query certain types of chaincode.

A blockchain developer 610 can write chaincode and client-side applications. The blockchain developer 610 can deploy chaincode directly to the network through an interface. To include credentials from a traditional data source 612 in chaincode, the developer 610 may use an out-of-band connection to access the data. In this example, the blockchain user 602 connects to the permissioned blockchain 604 through one of peer nodes 614 (referring to any one of nodes 614a-e). Before proceeding with any transactions, the peer node 614 (e.g., node 614a) retrieves the user's enrollment and transaction certificates from a certificate authority 616, which manages user roles and permissions. In some cases, blockchain users must possess these digital certificates in order to transact on the permissioned blockchain 604. Meanwhile, a user attempting to utilize chaincode may be required to verify their credentials on the traditional data source 612. To confirm the user's authorization, chaincode can use an out-of-band connection to this data through a traditional processing platform 618.

FIG. 6B illustrates another example of a permissioned blockchain network 620, which features a distributed, decentralized peer-to-peer architecture. In this example, a blockchain user 622 may submit a transaction to the permissioned blockchain 624. In this example, the transaction can be a deploy, invoke, or query, and may be issued through a client-side application leveraging an SDK, directly through an API, etc. Networks may provide access to a regulator 626, such as an auditor. A blockchain network operator 628 manages member permissions, such as enrolling the regulator 626 as an “auditor” and the blockchain user 622 as a “client.” An auditor may be restricted to only querying the ledger whereas a client may be authorized to deploy, invoke, and query certain types of chaincode.

A blockchain developer 630 writes chaincode and client-side applications. The blockchain developer 630 can deploy chaincode directly to the network through an interface. To include credentials from a traditional data source 632 in chaincode, the developer 630 may use an out-of-band connection to access the data. In this example, the blockchain user 622 connects to the network through a peer node 634. Before proceeding with any transactions, the peer node 634 retrieves the user's enrollment and transaction certificates from the certificate authority 636. In some cases, blockchain users must possess these digital certificates in order to transact on the permissioned blockchain 624. Meanwhile, a user attempting to utilize chaincode may be required to verify their credentials on the traditional data source 632. To confirm the user's authorization, chaincode can use an out-of-band connection to this data through a traditional processing platform 638.

In some embodiments of the present disclosure, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 6C illustrates a process 650 of a transaction being processed by a permissionless blockchain 652 including a plurality of nodes 654. A sender 656 desires to send payment or some other form of value (e.g., a deed, medical records, a contract, a good, a service, or any other asset that can be encapsulated in a digital record) to a recipient 658 via the permissionless blockchain 652. In some embodiments, each of the sender device 656 and the recipient device 658 may have digital wallets (associated with the blockchain 652) that provide user interface controls and a display of transaction parameters. In response, the transaction is broadcast throughout the blockchain 652 to the nodes 654.

Depending on the blockchain's 652 network parameters the nodes verify 660 the transaction based on rules (which may be pre-defined or dynamically allocated) established by the permissionless blockchain 652 creators. For example, this may include verifying identities of the parties involved, etc. The transaction may be verified immediately or it may be placed in a queue with other transactions and the nodes 654 determine if the transactions are valid based on a set of network rules.

In structure 662, valid transactions are formed into a block and sealed with a lock (hash). This process may be performed by mining nodes among the nodes 654. Mining nodes may utilize additional software specifically for mining and creating blocks for the permissionless blockchain 652. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 652 may include a proof-of-work (PoW) which is a solution to a puzzle derived from the block's header. Although not shown in the example of FIG. 6C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 664, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 666, the successfully validated block is distributed through the permissionless blockchain 652 and all nodes 654 add the block to a majority chain which is the permissionless blockchain's 652 auditable ledger. Furthermore, the value in the transaction submitted by the sender 656 is deposited or otherwise transferred to the digital wallet of the recipient device 658.

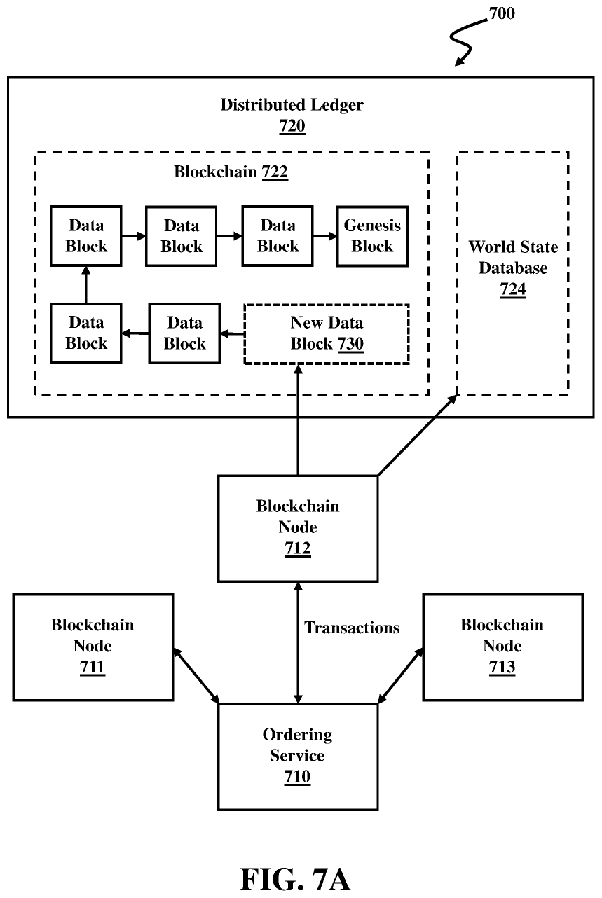

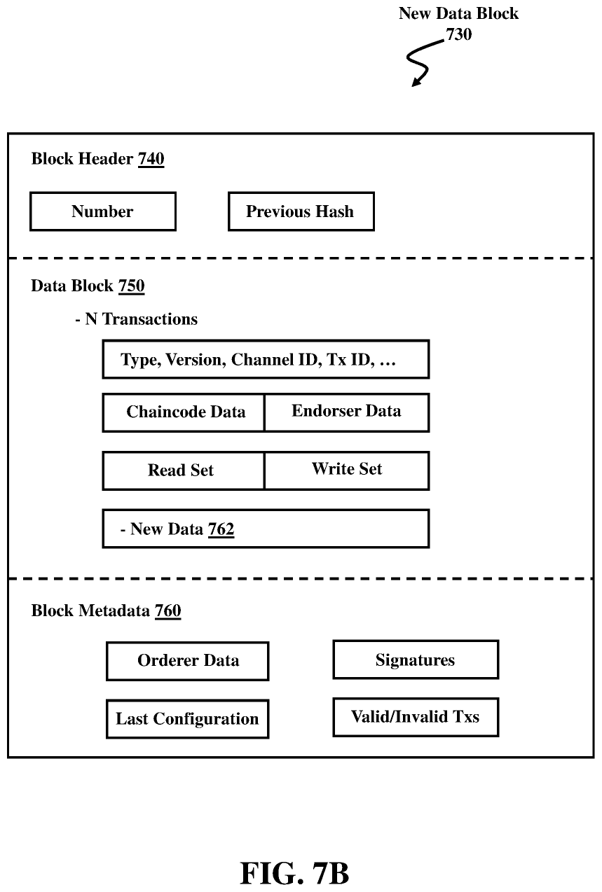

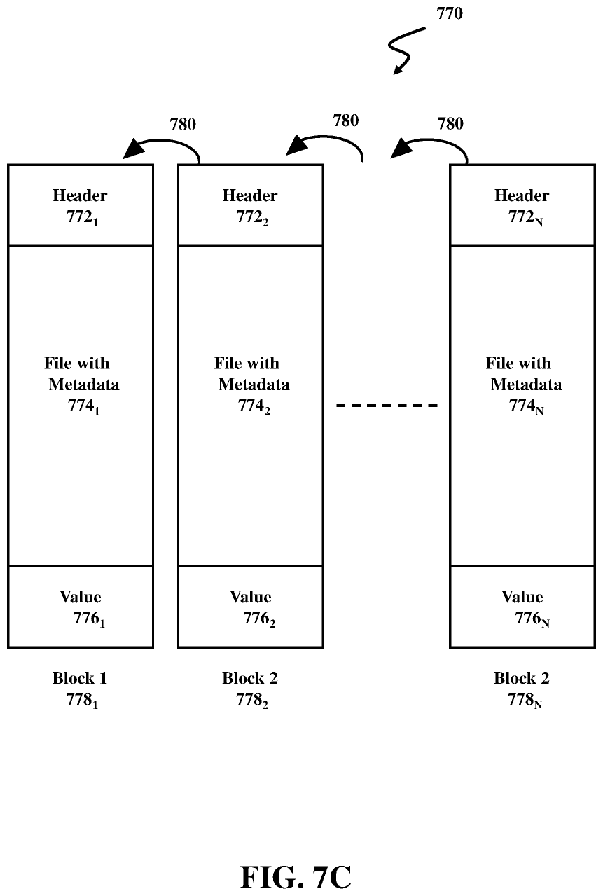

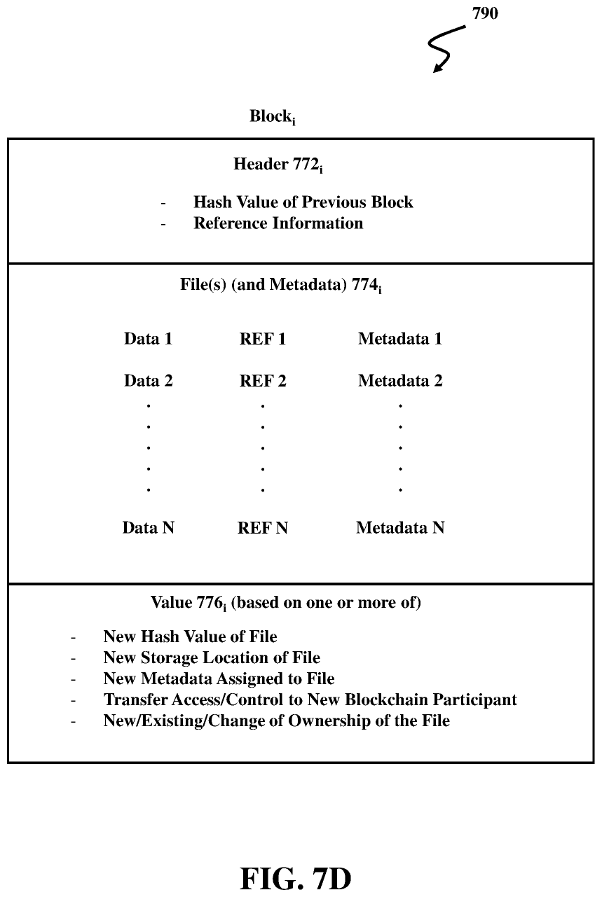

FIG. 7A illustrates a process 700 of a new block being added to a distributed ledger 720, according to example embodiments, and FIG. 7B illustrates contents of a new data block structure 730 for blockchain, according to example embodiments. The new data block 730 may contain document linking data.

Referring to FIG. 7A, clients (not shown) may submit transactions to blockchain nodes 711, 712, and/or 713. Clients may be instructions received from any source to enact activity on the blockchain 720. As an example, clients may be applications that act on behalf of a requester, such as a device, person or entity to propose transactions for the blockchain. The plurality of blockchain peers (e.g., blockchain nodes 711, 712, and 713) may maintain a state of the blockchain network and a copy of the distributed ledger 720. Different types of blockchain nodes/peers may be present in the blockchain network including endorsing peers which simulate and endorse transactions proposed by clients and committing peers which verify endorsements, validate transactions, and commit transactions to the distributed ledger 720. In this example, the blockchain nodes 711, 712, and 713 may perform the role of endorser node, committer node, or both.

The distributed ledger 720 includes a blockchain which stores immutable, sequenced records in blocks, and a state database 724 (current world state) maintaining a current state of the blockchain 722. One distributed ledger 720 may exist per channel and each peer maintains its own copy of the distributed ledger 720 for each channel of which they are a member. The blockchain 722 is a transaction log, structured as hash-linked blocks where each block contains a sequence of N transactions. Blocks may include various components such as shown in FIG. 7B. The linking of the blocks (shown by arrows in FIG. 7A) may be generated by adding a hash of a prior block's header within a block header of a current block. In this way, all transactions on the blockchain 722 are sequenced and cryptographically linked together preventing tampering with blockchain data without breaking the hash links. Furthermore, because of the links, the latest block in the blockchain 722 represents every transaction that has come before it. The blockchain 722 may be stored on a peer file system (local or attached storage), which supports an append-only blockchain workload.

The current state of the blockchain 722 and the distributed ledger 722 may be stored in the state database 724. Here, the current state data represents the latest values for all keys ever included in the chain transaction log of the blockchain 722. Chaincode invocations execute transactions against the current state in the state database 724. To make these chaincode interactions extremely efficient, the latest values of all keys are stored in the state database 724. The state database 724 may include an indexed view into the transaction log of the blockchain 722, it can therefore be regenerated from the chain at any time. The state database 724 may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing node creates a transaction endorsement which is a signed response from the endorsing node to the client application indicating the endorsement of the simulated transaction. The method of endorsing a transaction depends on an endorsement policy which may be specified within chaincode. An example of an endorsement policy is “the majority of endorsing peers must endorse the transaction.” Different channels may have different endorsement policies. Endorsed transactions are forward by the client application to ordering service 710.

The ordering service 710 accepts endorsed transactions, orders them into a block, and delivers the blocks to the committing peers. For example, the ordering service 710 may initiate a new block when a threshold of transactions has been reached, a timer times out, or another condition. In the example of FIG. 7A, blockchain node 712 is a committing peer that has received a new data new data block 730 for storage on blockchain 720. The first block in the blockchain may be referred to as a genesis block which includes information about the blockchain, its members, the data stored therein, etc.

The ordering service 710 may be made up of a cluster of orderers. The ordering service 710 does not process transactions, smart contracts, or maintain the shared ledger. Rather, the ordering service 710 may accept the endorsed transactions and specifies the order in which those transactions are committed to the distributed ledger 720. The architecture of the blockchain network may be designed such that the specific implementation of ‘ordering’ (e.g., Solo, Kafka, BFT, etc.) becomes a pluggable component.

Transactions are written to the distributed ledger 720 in a consistent order. The order of transactions is established to ensure that the updates to the state database 724 are valid when they are committed to the network. Unlike a cryptocurrency blockchain system (e.g., Bitcoin, etc.) where ordering occurs through the solving of a cryptographic puzzle, or mining, in this example the parties of the distributed ledger 720 may choose the ordering mechanism that best suits that network.

When the ordering service 710 initializes a new data block 730, the new data block 730 may be broadcast to committing peers (e.g., blockchain nodes 711, 712, and 713). In response, each committing peer validates the transaction within the new data block 730 by checking to make sure that the read set and the write set still match the current world state in the state database 724. Specifically, the committing peer can determine whether the read data that existed when the endorsers simulated the transaction is identical to the current world state in the state database 724. When the committing peer validates the transaction, the transaction is written to the blockchain 722 on the distributed ledger 720, and the state database 724 is updated with the write data from the read-write set. If a transaction fails, that is, if the committing peer finds that the read-write set does not match the current world state in the state database 724, the transaction ordered into a block may still be included in that block, but it may be marked as invalid, and the state database 724 may not be updated.

Referring to FIG. 7B, a new data block 730 (also referred to as a data block) that is stored on the blockchain 722 of the distributed ledger 720 may include multiple data segments such as a block header 740, block data 750, and block metadata 760. It should be appreciated that the various depicted blocks and their contents, such as new data block 730 and its contents. Shown in FIG. 7B are merely examples and are not meant to limit the scope of the example embodiments. The new data block 730 may store transactional information of N transaction(s) (e.g., 1, 10, 100, 500, 1000, 2000, 3000, etc.) within the block data 750. The new data block 730 may also include a link to a previous block (e.g., on the blockchain 722 in FIG. 7A) within the block header 740. In particular, the block header 740 may include a hash of a previous block's header. The block header 740 may also include a unique block number, a hash of the block data 750 of the new data block 730, and the like. The block number of the new data block 730 may be unique and assigned in various orders, such as an incremental/sequential order starting from zero.

The block data 750 may store transactional information of each transaction that is recorded within the new data block 730. For example, the transaction data may include one or more of a type of the transaction, a version, a timestamp, a channel ID of the distributed ledger 720, a transaction ID, an epoch, a payload visibility, a chaincode path (deploy tx), a chaincode name, a chaincode version, input (chaincode and functions), a client (creator) identify such as a public key and certificate, a signature of the client, identities of endorsers, endorser signatures, a proposal hash, chaincode events, response status, namespace, a read set (list of key and version read by the transaction, etc.), a write set (list of key and value, etc.), a start key, an end key, a list of keys, a Merkel tree query summary, and the like. The transaction data may be stored for each of the N transactions.

In some embodiments, the block data 750 may also store new data 762 which adds additional information to the hash-linked chain of blocks in the blockchain 722. The additional information includes one or more of the steps, features, processes and/or actions described or depicted herein. Accordingly, the new data 762 can be stored in an immutable log of blocks on the distributed ledger 720. Some of the benefits of storing such new data 762 are reflected in the various embodiments disclosed and depicted herein. Although in FIG. 7B the new data 762 is depicted in the block data 750 but may also be located in the block header 740 or the block metadata 760. The new data 762 may include a document composite key that is used for linking the documents within an organization.

The block metadata 760 may store multiple fields of metadata (e.g., as a byte array, etc.). Metadata fields may include signature on block creation, a reference to a last configuration block, a transaction filter identifying valid and invalid transactions within the block, last offset persisted of an ordering service that ordered the block, and the like. The signature, the last configuration block, and the orderer metadata may be added by the ordering service 710. Meanwhile, a committer of the block (such as blockchain node 712) may add validity/invalidity information based on an endorsement policy, verification of read/write sets, and the like. The transaction filter may include a byte array of a size equal to the number of transactions in the block data 750 and a validation code identifying whether a transaction was valid/invalid.

FIG. 7C illustrates an embodiment of a blockchain 770 for digital content in accordance with the embodiments described herein. The digital content may include one or more files and associated information. The files may include media, images, video, audio, text, links, graphics, animations, web pages, documents, or other forms of digital content. The immutable, append-only aspects of the blockchain serve as a safeguard to protect the integrity, validity, and authenticity of the digital content, making it suitable use in legal proceedings where admissibility rules apply or other settings where evidence is taken in to consideration or where the presentation and use of digital information is otherwise of interest. In this case, the digital content may be referred to as digital evidence.

The blockchain may be formed in various ways. In some embodiments, the digital content may be included in and accessed from the blockchain itself. For example, each block of the blockchain may store a hash value of reference information (e.g., header, value, etc.) along the associated digital content. The hash value and associated digital content may then be encrypted together. Thus, the digital content of each block may be accessed by decrypting each block in the blockchain, and the hash value of each block may be used as a basis to reference a previous block. This may be illustrated as follows:

| Block 1 | Block 2 | . . . | Block N |
|---|---|---|---|
| Hash Value 1 | Hash Value 2 | | Hash Value N |
| Digital Content 1 | Digital Content 2 | | Digital Content N |

In some embodiments, the digital content may be not included in the blockchain. For example, the blockchain may store the encrypted hashes of the content of each block without any of the digital content. The digital content may be stored in another storage area or memory address in association with the hash value of the original file. The other storage area may be the same storage device used to store the blockchain or may be a different storage area or even a separate relational database. The digital content of each block may be referenced or accessed by obtaining or querying the hash value of a block of interest and then looking up that has value in the storage area, which is stored in correspondence with the actual digital content. This operation may be performed, for example, a database gatekeeper. This may be illustrated as follows:

| Blockchain | Storage Area |
|---|---|
| Block 1 Hash Value | Block 1 Hash Value . . . Content |
| . . . | . . . |
| Block N Hash Value | Block N Hash Value . . . Content |

In the example embodiment of FIG. 7C, the blockchain 770 includes a number of blocks 7781, 7782, . . . 778N cryptographically linked in an ordered sequence, where N≥1. The encryption used to link the blocks 7781, 7782, . . . 778N may be any of a number of keyed or un-keyed Hash functions. In some embodiments, the blocks 7781, 7782, . . . 778N are subject to a hash function which produces n-bit alphanumeric outputs (where n is 256 or another number) from inputs that are based on information in the blocks. Examples of such a hash function include, but are not limited to, a SHA-type (SHA stands for Secured Hash Algorithm) algorithm, Merkle-Damgard algorithm, HAIFA algorithm, Merkle-tree algorithm, nonce-based algorithm, and a non-collision-resistant PRF algorithm. In other embodiments, the blocks 7781, 7782, . . . , 778N may be cryptographically linked by a function that is different from a hash function. For purposes of illustration, the following description is made with reference to a hash function, e.g., SHA-2.

Each of the blocks 7781, 7782, . . . , 778N in the blockchain includes a header, a version of the file, and a value. The header and the value are different for each block as a result of hashing in the blockchain. In some embodiments, the value may be included in the header. As described in greater detail below, the version of the file may be the original file or a different version of the original file.

The first block 7781 in the blockchain is referred to as the genesis block and includes the header 7721, original file 7741, and an initial value 7761. The hashing scheme used for the genesis block, and indeed in all subsequent blocks, may vary. For example, all the information in the first block 7781 may be hashed together and at one time, or each or a portion of the information in the first block 7781 may be separately hashed and then a hash of the separately hashed portions may be performed.

The header 7721 may include one or more initial parameters, which, for example, may include a version number, timestamp, nonce, root information, difficulty level, consensus protocol, duration, media format, source, descriptive keywords, and/or other information associated with original file 7741 and/or the blockchain. The header 7721 may be generated automatically (e.g., by blockchain network managing software) or manually by a blockchain participant. Unlike the header in other blocks 7782 to 778N in the blockchain, the header 7721 in the genesis block does not reference a previous block, simply because there is no previous block.

The original file 7741 in the genesis block may be, for example, data as captured by a device with or without processing prior to its inclusion in the blockchain. The original file 7741 is received through the interface of the system from the device, media source, or node. The original file 7741 is associated with metadata, which, for example, may be generated by a user, the device, and/or the system processor, either manually or automatically. The metadata may be included in the first block 7781 in association with the original file 7741.

The value 7761 in the genesis block is an initial value generated based on one or more unique attributes of the original file 7741. In some embodiments, the one or more unique attributes may include the hash value for the original file 7741, metadata for the original file 7741, and other information associated with the file. In one implementation, the initial value 7761 may be based on the following unique attributes:
1) SHA-2 computed hash value for the original file
2) originating device ID
3) starting timestamp for the original file
4) initial storage location of the original file
5) blockchain network member ID for software to currently control the original file and associated metadata

The other blocks 7782 to 778N in the blockchain also have headers, files, and values. However, unlike header 7721 the first block, each of the headers 7722 to 772N in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 780, to establish an auditable and immutable chain-of-custody.

Each of the header 7722 to 772N in the other blocks may also include other information, e.g., version number, timestamp, nonce, root information, difficulty level, consensus protocol, and/or other parameters or information associated with the corresponding files and/or the blockchain in general.

The files 7742 to 774N in the other blocks may be equal to the original file or may be a modified version of the original file in the genesis block depending, for example, on the type of processing performed. The type of processing performed may vary from block to block. The processing may involve, for example, any modification of a file in a preceding block, such as redacting information or otherwise changing the content of, taking information away from, or adding or appending information to the files.

Additionally, or alternatively, the processing may involve merely copying the file from a preceding block, changing a storage location of the file, analyzing the file from one or more preceding blocks, moving the file from one storage or memory location to another, or performing action relative to the file of the blockchain and/or its associated metadata. Processing which involves analyzing a file may include, for example, appending, including, or otherwise associating various analytics, statistics, or other information associated with the file.

The values in each of the other blocks 7762 to 776N in the other blocks are unique values and are all different as a result of the processing performed. For example, the value in any one block corresponds to an updated version of the value in the previous block. The update is reflected in the hash of the block to which the value is assigned. The values of the blocks therefore provide an indication of what processing was performed in the blocks and also permit a tracing through the blockchain back to the original file. This tracking confirms the chain-of-custody of the file throughout the entire blockchain.

For example, consider the case where portions of the file in a previous block are redacted, blocked out, or pixelated in order to protect the identity of a person shown in the file. In this case, the block including the redacted file may include metadata associated with the redacted file, e.g., how the redaction was performed, who performed the redaction, timestamps where the redaction(s) occurred, etc. The metadata may be hashed to form the value. Because the metadata for the block is different from the information that was hashed to form the value in the previous block, the values are different from one another and may be recovered when decrypted.

In some embodiments, the value of a previous block may be updated (e.g., a new hash value computed) to form the value of a current block when any one or more of the following occurs. The new hash value may be computed by hashing all or a portion of the information noted below, in this example embodiment.

a) new SHA-2 computed hash value if the file has been processed in any way (e.g., if the file was redacted, copied, altered, accessed, or some other action was taken)

b) new storage location for the file

c) new metadata identified associated with the file

d) transfer of access or control of the file from one blockchain participant to another blockchain participant

FIG. 7D illustrates an embodiment of a block which may represent the structure of the blocks in the blockchain 790 in accordance with one embodiment. The block, Blocki, includes a header 772i, a file 774i, and a value 776i.

The header 772i includes a hash value of a previous block Blocki−1 and additional reference information, which, for example, may be any of the types of information (e.g., header information including references, characteristics, parameters, etc.) discussed herein. All blocks reference the hash of a previous block except, of course, the genesis block. The hash value of the previous block may be just a hash of the header in the previous block or a hash of all or a portion of the information in the previous block, including the file and metadata.

The file 774i includes a plurality of data, such as Data 1, Data 2, . . . , Data N in sequence. The data are tagged with Metadata 1, Metadata 2, . . . , Metadata N which describe the content and/or characteristics associated with the data. For example, the metadata for each data may include information to indicate a timestamp for the data, process the data, keywords indicating the persons or other content depicted in the data, and/or other features that may be helpful to establish the validity and content of the file as a whole, and particularly its use a digital evidence, for example, as described in connection with an embodiment discussed below. In addition to the metadata, each data may be tagged with reference REF1, REF2, . . . , REFN to a previous data to prevent tampering, gaps in the file, and sequential reference through the file.

Once the metadata is assigned to the data (e.g., through a smart contract), the metadata cannot be altered without the hash changing, which can easily be identified for invalidation. The metadata, thus, creates a data log of information that may be accessed for use by participants in the blockchain.

The value 776i is a hash value or other value computed based on any of the types of information previously discussed. For example, for any given block Blocki, the value for that block may be updated to reflect the processing that was performed for that block, e.g., new hash value, new storage location, new metadata for the associated file, transfer of control or access, identifier, or other action or information to be added. Although the value in each block is shown to be separate from the metadata for the data of the file and header, the value may be based, in part or whole, on this metadata in another embodiment.

Once the blockchain 770 is formed, at any point in time, the immutable chain-of-custody for the file may be obtained by querying the blockchain for the transaction history of the values across the blocks. This query, or tracking procedure, may begin with decrypting the value of the block that is most currently included (e.g., the last (Nth) block), and then continuing to decrypt the value of the other blocks until the genesis block is reached and the original file is recovered. The decryption may involve decrypting the headers and files and associated metadata at each block, as well.

Decryption is performed based on the type of encryption that took place in each block. This may involve the use of private keys, public keys, or a public key-private key pair. For example, when asymmetric encryption is used, blockchain participants or a processor in the network may generate a public key and private key pair using a predetermined algorithm. The public key and private key are associated with each other through some mathematical relationship. The public key may be distributed publicly to serve as an address to receive messages from other users, e.g., an IP address or home address. The private key is kept secret and used to digitally sign messages sent to other blockchain participants. The signature is included in the message so that the recipient can verify using the public key of the sender. This way, the recipient can be sure that only the sender may have sent this message.

Generating a key pair may be analogous to creating an account on the blockchain, but without having to actually register anywhere. Also, every transaction that is executed on the blockchain is digitally signed by the sender using their private key. This signature ensures that only the owner of the account can track and process (if within the scope of permission determined by a smart contract) the file of the blockchain.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

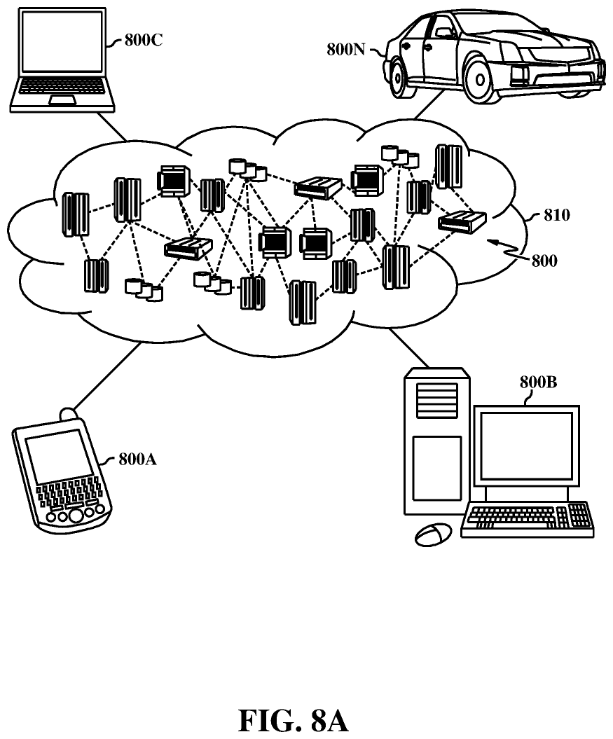

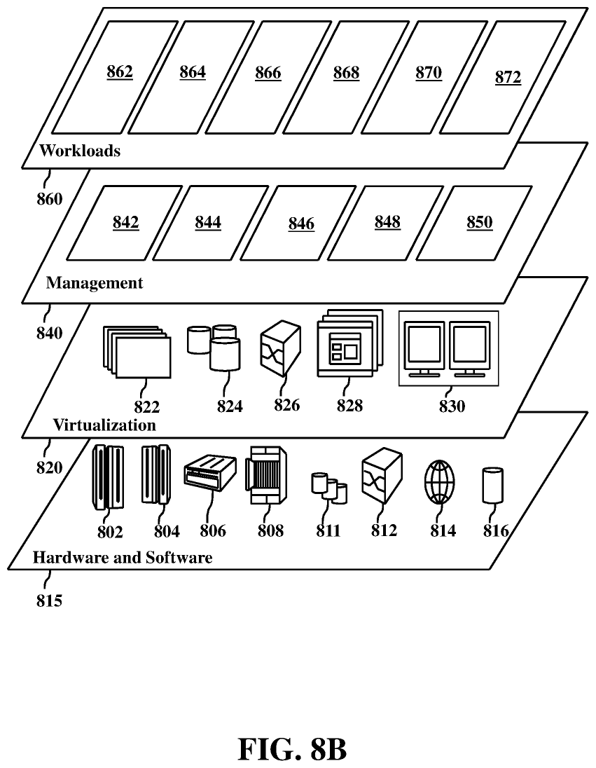

FIG. 8A, illustrated is a cloud computing environment 810 is depicted. As shown, cloud computing environment 810 includes one or more cloud computing nodes 800 with which local computing devices used by cloud consumers, such as, for example, personal digital assistant (PDA) or cellular telephone 800A, desktop computer 800B, laptop computer 800C, and/or automobile computer system 800N may communicate. Nodes 800 may communicate with one another. They may be grouped (not shown) physically or virtually, in one or more networks, such as Private, Community, Public, or Hybrid clouds as described hereinabove, or a combination thereof.

This allows cloud computing environment 810 to offer infrastructure, platforms and/or software as services for which a cloud consumer does not need to maintain resources on a local computing device. It is understood that the types of computing devices 800A-N shown in FIG. 8A are intended to be illustrative only and that computing nodes 800 and cloud computing environment 810 can communicate with any type of computerized device over any type of network and/or network addressable connection (e.g., using a web browser).

FIG. 8B, illustrated is a set of functional abstraction layers provided by cloud computing environment 810 (FIG. 8A) is shown. It should be understood in advance that the components, layers, and functions shown in FIG. 8B are intended to be illustrative only and embodiments of the disclosure are not limited thereto. As depicted below, the following layers and corresponding functions are provided.

Hardware and software layer 815 includes hardware and software components. Examples of hardware components include: mainframes 802; RISC (Reduced Instruction Set Computer) architecture based servers 804; servers 806; blade servers 808; storage devices 811; and networks and networking components 812. In some embodiments, software components include network application server software 814 and database software 816.

Virtualization layer 820 provides an abstraction layer from which the following examples of virtual entities may be provided: virtual servers 822; virtual storage 824; virtual networks 826, including virtual private networks; virtual applications and operating systems 828; and virtual clients 830.

In one example, management layer 840 may provide the functions described below. Resource provisioning 842 provides dynamic procurement of computing resources and other resources that are utilized to perform tasks within the cloud computing environment. Metering and Pricing 844 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 846 provides access to the cloud computing environment for consumers and system administrators. Service level management 848 provides cloud computing resource allocation and management such that required service levels are met. Service Level Agreement (SLA) planning and fulfillment 850 provide pre-arrangement for, and procurement of, cloud computing resources for which a future requirement is anticipated in accordance with an SLA.

Workloads layer 860 provides examples of functionality for which the cloud computing environment may be utilized. Examples of workloads and functions which may be provided from this layer include: mapping and navigation 862; software development and lifecycle management 864; virtual classroom education delivery 866; data analytics processing 868; transaction processing 870; and atomic committing 872.

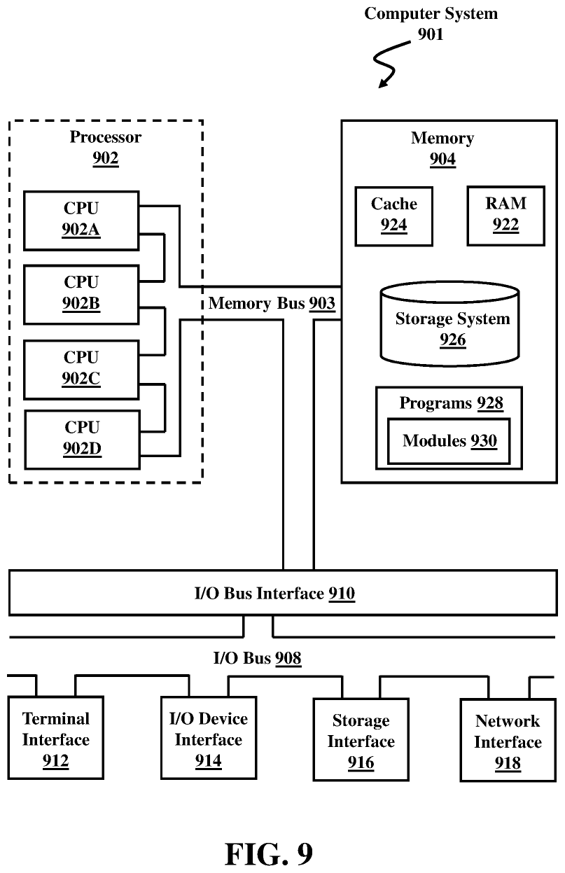

FIG. 9, illustrated is a high-level block diagram of an example computer system 901 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 901 may comprise one or more CPUs 902, a memory subsystem 904, a terminal interface 912, a storage interface 916, an I/O (Input/Output) device interface 914, and a network interface 918, all of which may be communicatively coupled, directly or indirectly, for inter-component communication via a memory bus 903, an I/O bus 908, and an I/O bus interface unit 910.

The computer system 901 may contain one or more general-purpose programmable central processing units (CPUs) 902A, 902B, 902C, and 902D, herein generically referred to as the CPU 902. In some embodiments, the computer system 901 may contain multiple processors typical of a relatively large system; however, in other embodiments the computer system 901 may alternatively be a single CPU system. Each CPU 902 may execute instructions stored in the memory subsystem 904 and may include one or more levels of on-board cache.

System memory 904 may include computer system readable media in the form of volatile memory, such as random access memory (RAM) 922 or cache memory 924. Computer system 901 may further include other removable/non-removable, volatile/non-volatile computer system storage media. By way of example only, storage system 926 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 904 can include flash memory, e.g., a flash memory stick drive or a flash drive. Memory devices can be connected to memory bus 903 by one or more data media interfaces. The memory 904 may include at least one program product having a set (e.g., at least one) of program modules that are configured to carry out the functions of various embodiments.

One or more programs/utilities 928, each having at least one set of program modules 930 may be stored in memory 904. The programs/utilities 928 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 928 and/or program modules 930 generally perform the functions or methodologies of various embodiments.

Although the memory bus 903 is shown in FIG. 9 as a single bus structure providing a direct communication path among the CPUs 902, the memory subsystem 904, and the I/O bus interface 910, the memory bus 903 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 910 and the I/O bus 908 are shown as single respective units, the computer system 901 may, in some embodiments, contain multiple I/O bus interface units 910, multiple I/O buses 908, or both. Further, while multiple I/O interface units are shown, which separate the I/O bus 908 from various communications paths running to the various I/O devices, in other embodiments some or all of the I/O devices may be connected directly to one or more system I/O buses.

In some embodiments, the computer system 901 may be a multi-user mainframe computer system, a single-user system, or a server computer or similar device that has little or no direct user interface, but receives requests from other computer systems (clients). Further, in some embodiments, the computer system 901 may be implemented as a desktop computer, portable computer, laptop or notebook computer, tablet computer, pocket computer, telephone, smartphone, network switches or routers, or any other appropriate type of electronic device.

It is noted that FIG. 9 is intended to depict the representative major components of an exemplary computer system 901. In some embodiments, however, individual components may have greater or lesser complexity than as represented in FIG. 9, components other than or in addition to those shown in FIG. 9 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A method comprising:
receiving, with a scheduler node in a blockchain network, data associated with a machine learning model;
measuring, with the scheduler node, a drift of the machine learning model for a first aspect of the data;
determining, with the scheduler node, that the drift of the machine learning model is greater than a drift threshold; and
scheduling, with the scheduler node and in response to the drift being greater than the drift threshold, a retraining transaction for the machine learning model.

2. The method of claim 1 further comprising:
determining, with the scheduler node, if the data is urgent, and
labeling the retraining transaction as an urgent transaction.

3. The method of claim 2 further comprising waiting, in response to a determination that the data is not urgent for a next scheduled transaction to perform the measuring.

4. The method of claim 1, wherein the measuring includes:
sending, with the scheduler node, a notification to a system drift measuring service to initiate a measurement of the drift of the machine learning model; and committing, with a node associated with the drift measuring service, the drift measurement to the blockchain network.

5. The method of claim 1, wherein the retraining further comprises:
sending, with the scheduler node, a notification to a machine learning model training service developer to initiate a retraining of the machine learning model;
receiving, with the scheduler node from the machine learning model training service developer, the retrained machine learning model; and
deploying the machine learning model.

6. The method of claim 1, wherein the model includes at least two sub-models.

7. The method of claim 6 further comprising:
identifying, from the at least two sub-models, a sub-model associated with the drift,
wherein the retraining is directed to the identified sub-model.

8. The method of claim 1 further comprising:
determining, with the scheduler node, that a second aspect of the data can be measured for a second drift measurement;
measuring, with the scheduler node, a second drift of the machine learning model for the second aspect of the data;
determining, with the scheduler node, that the second drift of the machine learning model is greater than a second drift threshold; and
retraining, with the scheduler node in response to the second drift being larger than the second drift threshold, the machine learning model.

9. A system comprising:
a processor in a node of a blockchain network; and
a memory in communication with the processor, the memory containing program instructions that, when executed by the processor, are configured to cause the processor to perform a method, the method comprising:
receiving data associated with a machine learning model;
measuring a drift of the machine learning model for a first aspect of the data;
determining that the drift of the machine learning model is greater than a drift threshold; and
retraining, in response to the drift being greater than the drift threshold, the machine learning model.

10. The system of claim 9 wherein the method further comprises, determining if the data is urgent.

11. The system of claim 10 wherein the method further comprises waiting, in response to a determination that the data is not urgent, for a next scheduled drift measurement to perform the measuring.

12. The system of claim 9, wherein the measuring includes:
sending, with the scheduler node, a notification to a system drift measuring service to initiate a measurement of the drift of the machine learning model; and
committing, with a node associated with the drift measuring service, the drift measurement to the blockchain network.

13. The system of claim 9, wherein a retraining further comprises:
sending, with the scheduler node, a notification to a machine learning model training service developer to initiate the retraining of the machine learning model;
receiving, with the scheduler node from the machine learning model training service developer, the retrained machine learning model; and
deploying the machine learning model.

14. The system of claim 9, wherein the model includes at least two sub-models.

15. The system of claim 14 wherein the method further comprises:
identifying, from the at least two sub-models, a sub-model associated with the drift,
wherein the retraining is directed to the identified sub-model.

16. The system of claim 14 wherein the method further comprises:
determining, with the scheduler node, that a second aspect of the data can be measured for a second drift measurement;
measuring, with the scheduler node, a second drift of the machine learning model for the second aspect of the data;
determining, with the scheduler node, that the second drift of the machine learning model is greater than a second drift threshold; and
retraining, with the scheduler node in response to the second drift being larger than the second drift threshold, the machine learning model.

17. A computer program product comprising a computer readable storage medium having program instructions embodied therewith, the program instructions executable with a processor, in a node of a blockchain network, to cause the processors to perform a function, the function comprising:
receive data associated with a machine learning model;
measure, with a scheduler node, a drift of the machine learning model for a first aspect of the data;
determine that the drift of the machine learning model is greater than a drift threshold; and
retrain in response to the drift being greater than the drift threshold, the machine learning model.

18. A method comprising:
receiving, with a scheduler node in a blockchain network, a scheduled transaction proposal containing a transaction and a schedule for executing the transaction;
waiting, with the scheduler node, for a scheduled transaction; and
executing, with the scheduler node, the scheduled transaction.

19. The method of claim 18, further comprising:
receiving, with the scheduler node, data associated with a machine learning model;
determining, with the scheduler node, if the data is urgent;
measuring, with the scheduler node and based on a determination that the data is urgent, a drift of the machine learning model for a first aspect of the data;
determining, with the scheduler node, that the drift of the machine learning model is greater than a drift threshold; and
executing, with the scheduler node and in response to the drift being greater than the drift threshold, an urgent transaction for the machine learning model.

20. The method of claim 20 further comprising waiting, in response to a determination that the data is not urgent for a next scheduled transaction.
